(19) United States
(12) Patent Application Publication
(10) Pub. No.: US 2008/0317094 A1
(43) Pub. Date: Dec. 25, 2008

(54) Temperature vector analyzer

(76) Inventors: James Huang, HsinChu (TW); Jason Liao, HsinChu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/076,130

(22) Filed: Mar. 14, 2008

(30) Foreign Application Priority Data
Mar. 16, 2007 (TW) 96109109

(51) Int. Cl. G01J 5/00

(52) U.S. Cl. 374/124

(57) ABSTRACT

The present invention discloses a temperature vector analyzer, which comprises the following elements: a temperature detection device further comprising a plurality of infrared sensors; a temperature-vector display panel; a microprocessor receiving infrared-radiating heat source temperatures detected by the plurality of infrared sensors, calculating the vector components of the infrared-radiating heat source temperatures to attain a center-originating temperature vector, and presenting the temperature vector on the temperature-vector display panel; and a power source providing power for the temperature detection device, the temperature-vector display panel, and the microprocessor. The present invention can apply to detect a local heat origin or a local heat-dissipating point.

### BACKGROUND OF THE INVENTION

1. Field of the Invention

The present invention relates to a temperature analyzer, particularly to a temperature vector analyzer.

2. Description of the Related Art

The middle/long-wavelength infrared thermography device is used to detect the surface temperature distribution in the fields of inspection, surveillance, medicine, industry, etc. and comprises the following three parts: an optical module, an infrared detection module and a calculation/control module, wherein the middle/long-wavelength infrared electromagnetic wave radiated by an object passes through the infrared-transparent optical module, and the infrared detection module receives the infrared energy passively and transforms the received infrared signals to obtain the surface temperature of the object; the surface temperature data is digitized, and the calculation/control module modifies and image-processes the digitized temperature data and presents the thermal image on the display of the infrared thermography device. However, such an infrared thermography device is usually high-priced because the lenses of the optical module, the special coating on the lenses, and the infrared sensors are very expensive. Thus, many organizations cannot by themselves undertake the thermography-related tasks, such as industrial inspection, environmental surveillance, medical examination, power-equipment preventive maintenance, etc., but have to farm them out.

Accordingly, the present invention proposes a simple-design and low-cost temperature vector analyzer, which can achieve the same efficacy of the conventional infrared thermography device, to solve the abovementioned problems.

### SUMMARY OF THE INVENTION

The primary objective of the present invention is to provide a temperature vector analyzer, which is cheaper than the infrared thermography device available in the market, and which is a tool for searching a local heat origin or a local heat-dissipating point.

Another objective of the present invention is to provide a temperature vector analyzer, which utilizes several infrared sensors to detect IR (infrared)-radiating heat sources at different positions of a local area and calculates the detection results to attain a center-originating temperature vector.

To achieve the abovementioned objectives, the present invention proposes a temperature vector analyzer, which comprises the following elements: a temperature detection device further comprising a plurality of infrared sensors; a temperature-vector display panel; a microprocessor receiving IR-radiating heat source temperatures detected by the plurality of infrared sensors, working out the vector components of the IR-radiating heat source temperatures to attain a center-originating temperature vector, and presenting the temperature vector on the temperature-vector display panel; and a power source providing power for the temperature detection device, the temperature-vector display panel, and the microprocessor.

The present invention also proposes a temperature vector analyzer, which comprises the following elements: a temperature detection device further comprising a central infrared sensor at the center thereof and a plurality of peripheral infrared sensors surrounding the central infrared sensor; a temperature-vector display panel; a microprocessor receiving infrared heat source temperatures detected by the central infrared sensor and the peripheral infrared sensors, working out the vector components of the IR-radiating heat source temperatures with the temperature detected by the central infrared sensor being the center to attain a center-originating temperature vector, and presenting the temperature vector on the temperature-vector display panel; and a power source providing power for the abovementioned elements.

Below, the embodiments are to be described in detail to make easily understood the objectives, technical contents, characteristics and accomplishments of the present invention.

### BRIEF DESCRIPTION OF THE DRAWINGS

FIG. 1 is a diagram schematically showing the architecture of the present invention;

FIG. 2 is a diagram schematically showing the temperature detection device according to one embodiment of the present invention;

FIG. 3 is a diagram showing the distribution of isotherms in the space where the infrared sensors exist;

FIG. 4 is a diagram schematically showing the calculation of the center-originating temperature vector with the temperature of the center adopting an operation-assigned temperature;

FIG. 5 is another diagram schematically showing the calculation of the center-originating temperature vector with the temperature of the center adopting an operation-assigned temperature;

FIG. 6 is a diagram schematically showing the calculation of the center-originating temperature vector with the temperature of the center adopting a physically-detected temperature;

FIG. 7 is a diagram schematically showing the temperature detection device according to another embodiment of the present invention;

FIG. 8(a) is a diagram schematically showing a design of the temperature-vector display panel according to the present invention; and

FIG. 8(b) is a diagram schematically showing another design of the temperature-vector display panel according to the present invention.

### DETAILED DESCRIPTION OF THE INVENTION

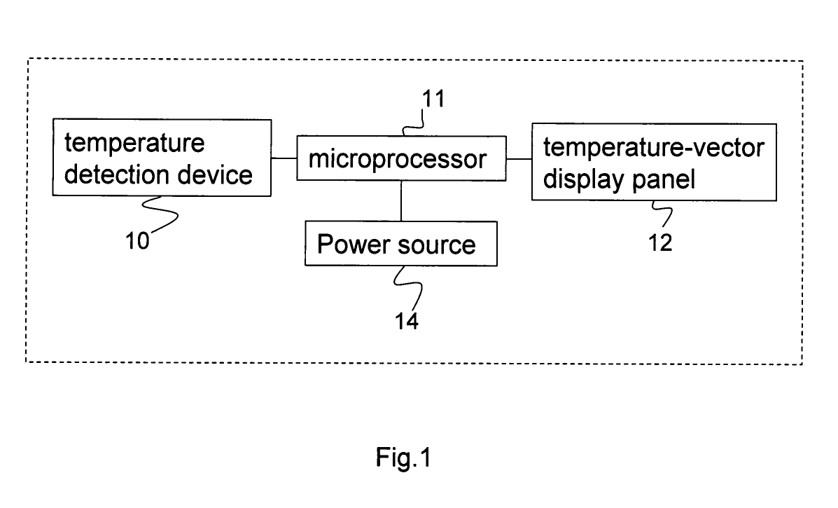

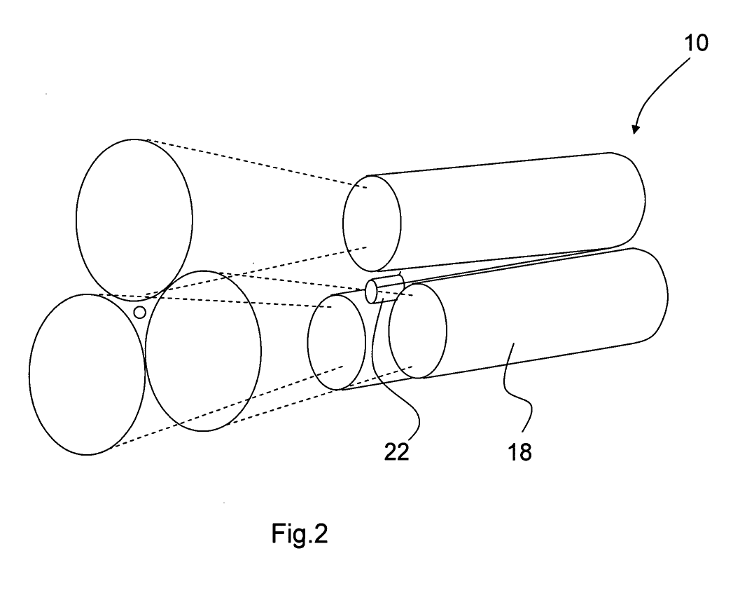

Refer to FIG. 1 a diagram schematically showing the architecture of the present invention. The temperature vector analyzer of the present invention comprises the following elements: a temperature detection device 10, a microprocessor 11, a temperature-vector display panel 12 and a power source 14 providing power for the abovementioned elements. Refer to FIG. 2. The spirit of the present invention is as follows: the temperature detection device 10 utilizes a plurality of infrared sensors 18 to detect temperatures of IR-radiating heat sources at different positions of a local area, and temperature vector components are worked out from the temperatures of the several IR-radiating heat sources to attain the center-originating temperature directivity (the directivity may point to low temperature or high temperature).

Based on the spirit stated above, three embodiments are used to exemplify the arrangement of the infrared sensors of the temperature detection device. Among the three embodiments described below, the temperature of the center (the original of vector) is operation-assigned in a first embodiment and a second embodiment, and a third embodiment adopts the physical temperature as the temperature of the center.

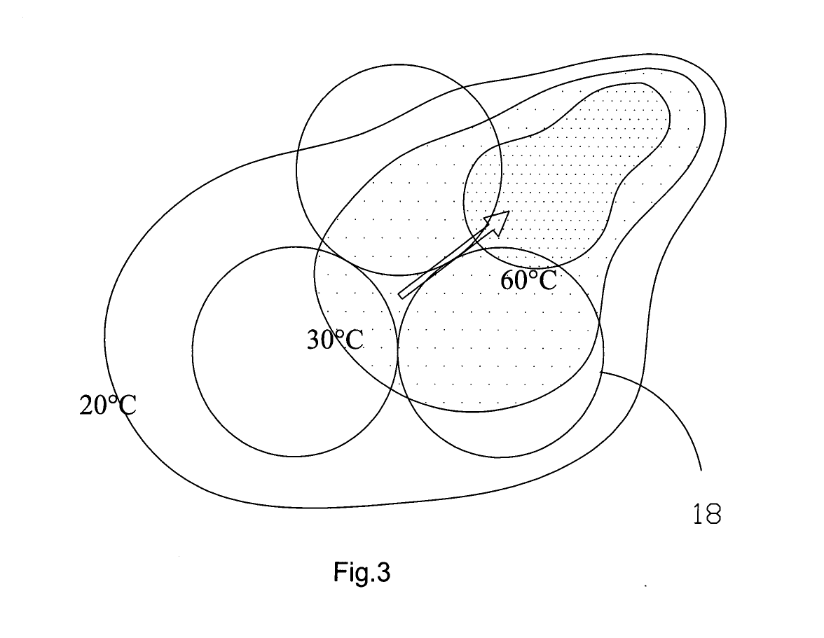

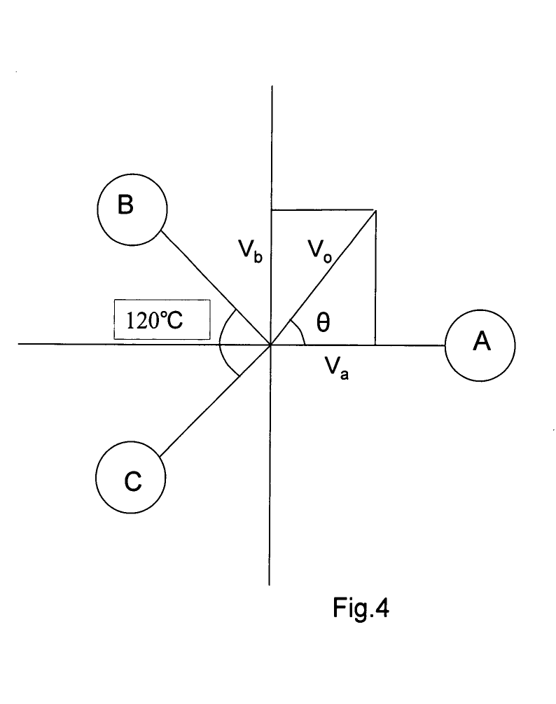

Firstly, the embodiments adopting the operation-assigned temperature as the temperature of the center are used to exemplify the present invention. Refer to FIG. 3 and FIG. 4 diagrams respectively showing the distribution of isotherms in the space where the infrared sensors 18 exist and the calculation of a temperature vector. In the first embodiment, three infrared sensors A, B and C are used to detect temperature.

Suppose that the infrared sensor A detects an IR-radiating heat source and obtains a temperature value Tₐ, that the infrared sensor B detects an IR-radiating heat source and obtains a temperature value T_{b}, and that the infrared sensor C detects an IR-radiating heat source and obtains a temperature value T_{c}.

In this embodiment, three infrared sensors are equally spaced by angles of 120 degrees and used to detect the plane of a local area. The following equations are used to calculate a temperature vector:

Vₐ=Tₐ cos 0°+T_{b} cos 120°+T_{c} cos 240°

V_{b}=Tₐ sin 0+T_{b} sin 120°+T_{c} sin 240°

V₀=\sqrt{Vₐ²+V_{b}²}

θ=a tan(V_{b}/Vₐ)

T₀=Tₐ−Vₐ (the temperature of the center when the higher-temperature point is at the left side of Tₐ)

wherein when the higher-temperature point is at the right side of Tₐ, the temperature of the center T₀ is Tₐ+Vₐ.

Thus, Vₐ and V_{b} can be worked out with trigonometric functions; Vₐ and V_{b} can further be used to work out the values of θ and the temperature of the center T₀. Then, the higher-temperature vector, the lower-temperature vector, or the special center-originating temperature vector can be determined. For example, the temperature vector shown in FIG. 3 points to the position of the 60° C. isotherm.

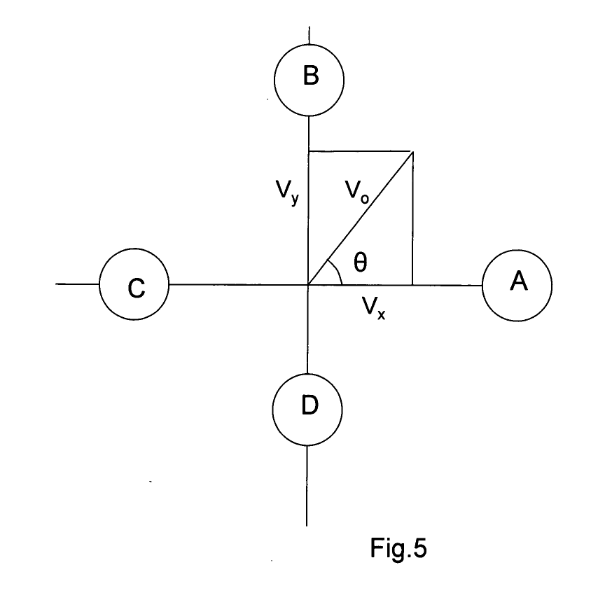

Refer to FIG. 5 for the second embodiment, wherein four infrared sensors A, B, C and D are used to detect temperature. Suppose that the infrared sensor A detects an IR-radiating heat source and obtains a temperature value Tₐ, that the infrared sensor B detects an IR-radiating heat source and obtains a temperature value T_{b}, that the infrared sensor C detects an IR-radiating heat source and obtains a temperature value T_{c}, and that the infrared sensor D detects an IR-radiating heat source and obtains a temperature value T_{d}. In this embodiment, four infrared sensors are equally spaced by angles of 90 degrees and used to detect the plane of a local area. The following equations are used to calculate a temperature vector:

Vₓ=Tₐ cos 0°+T_{b} cos 90°+T_{c} cos 180°+T_{d} cos 270°

V_{y}=Tₐ sin 0°+T_{b} sin 90°+T_{c} sin 180°+T_{d} sin 270°

V₀=\sqrt{V_{X}²+V_{Y}²}

θ=a tan(V_{y}/Vₓ)

T₀=Tₐ−Vₓ

Thus, Vₓ and V_{y} can be worked out with trigonometric functions; Vₓ and V_{y} can further be used to work out the value of θ and the temperature of the center T₀. Then, the higher-temperature vector, the lower-temperature vector, or the special center-originating temperature vector can be determined.

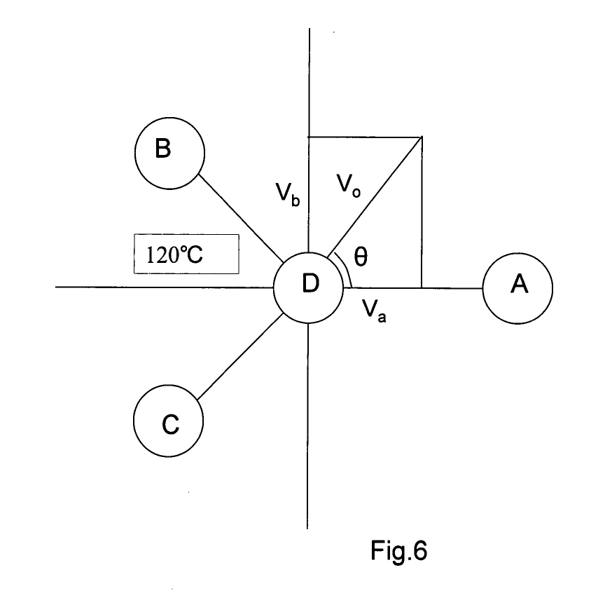

Refer to FIG. 6 for the third embodiment, wherein the temperature of the center adopts the temperature physically detected, and at least four infrared sensors are used to detect temperature, including a central infrared sensor D at the center of the temperature detection device and three peripheral infrared sensors A, B and C along the perimeter of the temperature detection device. The temperature physically detected by the central infrared sensor D is used as the temperature of the center. The related components and the center-originating temperature vector are worked out with the physical temperature value of the center and the temperature values of the IR-radiating heat sources obtained by the corresponding three peripheral infrared sensors A, B and C. In this embodiment, the temperature of the center does not adopt an operation-assigned temperature but adopts the temperature physically detected by the central infrared sensor D, and the physical temperature replaces the temperature of the center T₀ in FIG. 4.

Refer to FIG. 2 again. Further, in the embodiments adopting an operation-assigned temperature as the temperature of the center, the center of the temperature detection device may have a central laser marker 22, and the user can thus learn the center of the currently detected area.

After the description of the principle and vector-calculation method of the present invention, the maximum-temperature directivity and the minimum-temperature directivity are described below. In fact, the minimum-temperature directivity also implicates the direction of the highest temperature. Therefore,

when θ_{Max}□180°,θ_{Min}=θ_{Max}+180 °;

when θ_{Max}>180°,θ_{Min}=θ_{Max}−180°;

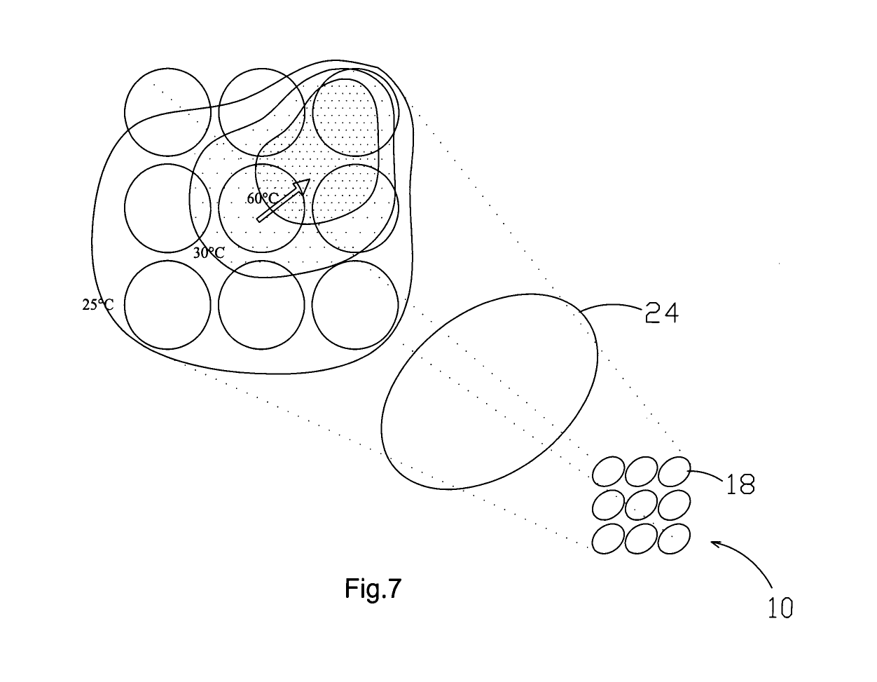

Refer to FIG. 7 for the fourth embodiment of the temperature vector analyzer according to the present invention, wherein the temperature detection device 10 has 9 infrared sensors 18 arranged by 3×3, and wherein an optical lens 24 is arranged in the front of the temperature detection device 10 to change the angle of vision. In this embodiment, more infrared sensors 18 are used to obtain more temperature values and increase the accuracy of detection results. The vector components of the infrared sensors 18 are used to work out a center-originating temperature vector. In this embodiment, the angles of vision of the infrared sensors 18 do not overlap. Similar to the abovementioned embodiments, the center of the temperature detection device 10 may have a central laser marker to indicate the origin (the center). As shown in FIG. 7, after vector calculation, the temperature vector points to the higher-temperature 60° C. isotherm.

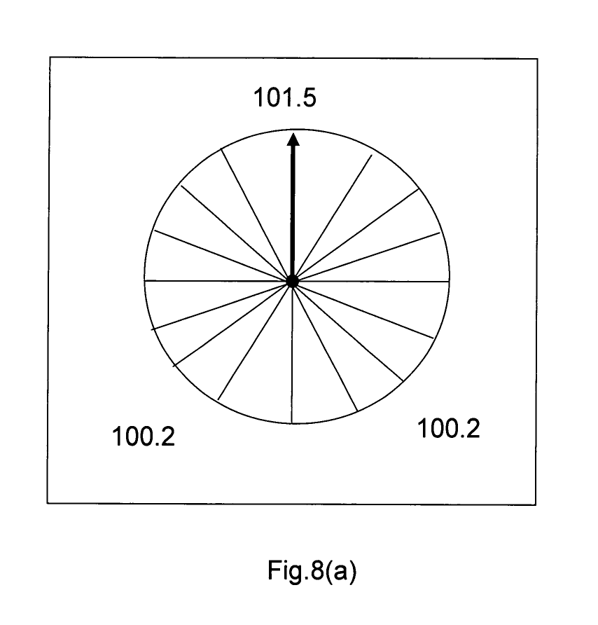

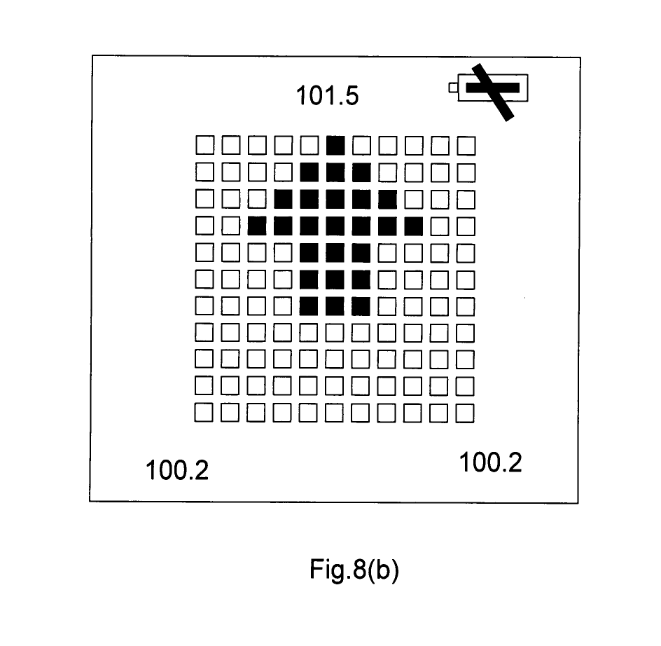

Refer to FIG. 8(a) and FIG. 8(b) diagrams schematically showing the designs of the temperature-vector display panel according to the present invention. As shown in the drawings, the IR-radiating heat source temperatures detected by the infrared sensors are presented on one temperature-vector display panel; based on the worked out angles, an arrow projecting outward from the center is used to indicate the direction and angle of the temperature bias (toward high temperature or low temperature). Further, an energy-storage indicator, switch-on animation, switch-off animation, operation animation, date-time, etc. may also be presented on the temperature-vector display panel.

In conclusion, the present invention proposes a temperature vector analyzer, which utilizes several infrared sensors to detect IR-radiating heat sources at different positions of a local area and calculates the detection results with trigonometric functions to attain a center-originating temperature vector and presents the temperature vector on a display panel. With a cost much lower than the conventional infrared thermography device, the present invention can detect objects, such as the cracks or damages in a building or a power supply device, and the directions of the damaged points with respect to the detection center. Further, the present invention may also be used to find out the positions of survivals in accident rescue.

The preferred embodiments described above are only to exemplify the present invention but not to limit the scope of the present invention. Any equivalent modification or variation according to the spirit of the present invention is to be also included within the scope of the present invention.

What is claimed is:

1. A temperature vector analyzer, comprising the following elements:
a temperature detection device further comprising a plurality of infrared sensors;
a temperature-vector display panel;
a microprocessor receiving infrared-radiating heat source temperatures detected by the plurality of said infrared sensors, working out the vector components of said IR-radiating heat source temperatures to attain a center-originating temperature vector, and presenting said temperature vector on said temperature-vector display panel; and
a power source providing power for said temperature detection device, said temperature-vector display panel, and said microprocessor.

2. The temperature vector analyzer according to claim 1, wherein a laser marker is arranged in the center of said temperature detection device.

3. The temperature vector analyzer according to claim 1, wherein an arrow sign is used to represent said center-originating temperature vector on said temperature-vector display panel.

4. The temperature vector analyzer according to claim 1, wherein said temperature-vector display panel displays an energy-storage indicator of said power source.

5. The temperature vector analyzer according to claim 1, wherein said temperature-vector display panel displays switch-on animation, switch-off animation, operation animation, date-time, etc.

6. The temperature vector analyzer according to claim 1 further comprising an optical lens arranged before said temperature detection device.

7. A temperature vector analyzer, comprising the following elements:
a temperature detection device further comprising a central infrared sensor at the center thereof and a plurality of peripheral infrared sensors along the perimeter of said central infrared sensor;
a temperature-vector display panel;
a microprocessor receiving infrared-radiating heat source temperatures detected by said central infrared sensor and said peripheral infrared sensors, working out vector components of said IR-radiating heat source temperatures with the temperature detected by said central infrared sensor being the center to attain a center-originating temperature vector, and presenting said temperature vector on said temperature-vector display panel; and
a power source providing power for said temperature detection device, said temperature-vector display panel, and said microprocessor.

8. The temperature vector analyzer according to claim 7, wherein a laser marker is arranged in the central of said infrared sensor.

9. The temperature vector analyzer according to claim 7, wherein an arrow sign is used to represent said center-originating temperature vector on said temperature-vector display panel.

10. The temperature vector analyzer according to claim 7, wherein said temperature-vector display panel displays an energy-storage indicator of said power source.

11. The temperature vector analyzer according to claim 7, wherein said temperature-vector display panel displays switch-on animation, switch-off animation, operation animation, date-time, etc.

12. The temperature vector analyzer according to claim 7 further comprising an optical lens arranged before said temperature detection device.
